(19) United States
(12) Patent Application Publication
(10) Pub. No.: US 2026/0034941 A1
(43) Pub. Date: Feb. 5, 2026

(54) GOLF VEHICLE WITH STORAGE COMPARTMENT

(71) Applicant: Textron Inc., Providence, RI (US)

(72) Inventors: Ricky Veldee Kemp, Augusta, GA (US); Trevor Douglas Roebuck, Evans, GA (US); Charles Daniel Dauchess, North Augusta, SC (US)

(73) Assignee: Textron Inc., Providence, RI (US)

(21) Appl. No.: 18/791,761

(22) Filed: Aug. 1, 2024

(51) Int. Cl. B60R 5/00; A63B 55/60; B60K 1/00; B60K 1/04; B60L 50/60; B60N 2/005

(52) U.S. Cl. CPC B60R 5/006; B60K 1/00; B60K 1/04; B60L 50/66; B60N 2/005; A63B 55/61; B60K 2001/0433; B60L 2200/22

(57) ABSTRACT

A golf vehicle includes a frame, a body coupled to the frame and defining a battery compartment, a tractive element coupled to the frame, an electric motor configured to drive the tractive element to propel the golf vehicle, a battery positioned within the battery compartment and configured to supply electrical energy to the electric motor, and a drawer movably coupled to the frame and extending rearward of the battery compartment. The drawer defines a storage volume.

### BACKGROUND

Certain vehicles are used to transport personnel and equipment between different areas. By way of example, a golf cart may transport golfers and equipment (e.g., golf bags, golf clubs, etc.) around a golf course (e.g., along a cart path, between different holes, etc.). It may be desirable to maximize the amount of storage space available within a vehicle without increasing the overall size of the vehicle (e.g., by maximizing usability of the available space onboard the vehicle).

### SUMMARY

One embodiment relates to a golf vehicle. The golf vehicle includes a frame, a body coupled to the frame and defining a battery compartment, a tractive element coupled to the frame, an electric motor configured to drive the tractive element to propel the golf vehicle, a battery positioned within the battery compartment and configured to supply electrical energy to the electric motor, and a drawer movably coupled to the frame and extending rearward of the battery compartment. The drawer defines a storage volume.

Another embodiment relates to an off-road machine. The off-road machine includes a frame, a front tractive assembly coupled to the frame and including a first tractive element, a rear tractive assembly coupled to the frame and including a second tractive element, a seat configured to support an operator, and a body. The seat extends forward of the rear tractive assembly. The body defines a storage volume extending forward of the second tractive element and rearward of the seat. The body includes a panel that is repositionable to selectively permit access to the storage volume from outside of the body.

Still another embodiment relates to a recreational vehicle. The recreational vehicle includes a frame including an upper frame portion and a lower frame portion, a seat box coupled to the frame and defining a battery compartment, a seat extending across the battery compartment and at least partially supported by the upper frame portion, and a tractive assembly coupled to the frame and extending rearward of the seat. The tractive assembly includes a tractive element and an electric motor configured to drive the tractive element to propel the golf vehicle. The golf vehicle further includes a battery positioned within the battery compartment and configured to supply electrical energy to the electric motor, a fender coupled to the frame and defining a wheel well that receives the tractive element, a bed pivotally coupled to the frame and extending above the upper frame portion, and a drawer slidably coupled to the frame and defining a storage volume. The drawer extends between the upper frame portion and the lower frame portion. The drawer extends between the seat box and the fender. The drawer extends between the electric motor and the battery. The drawer extends below the bed.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a front perspective view of a vehicle including a drawer in a closed position, according to an exemplary embodiment.

FIG. 5 is a front perspective view of the vehicle of FIG. 4 including the drawer in an open position, according to an exemplary embodiment.

FIG. 6 is a front perspective view of the vehicle of FIG. 4 including the drawer in the closed position, according to an exemplary embodiment.

FIG. 7 is a front perspective view of the vehicle of FIG. 4 including the drawer in the closed position, according to an exemplary embodiment.

FIG. 8 is a rear perspective view of the vehicle of FIG. 4 including the drawer in the closed position, according to an exemplary embodiment.

FIG. 9 is a right side view of the vehicle of FIG. 4 including the drawer in the closed position, according to an exemplary embodiment.

FIG. 10 is a front perspective view of the vehicle of FIG. 4 including the drawer in the open position, according to an exemplary embodiment.

FIG. 11 is a rear perspective view of the vehicle of FIG. 4 including the drawer in the open position, according to an exemplary embodiment.

FIG. 12 is a rear perspective view of the vehicle of FIG. 4 including the drawer in the open position, according to an exemplary embodiment.

FIG. 13 is a left side view of the vehicle of FIG. 4 including the drawer in the open position, according to an exemplary embodiment.

FIG. 14 is a rear view of the vehicle of FIG. 4 including the drawer in the open position, according to an exemplary embodiment.

FIG. 15 is a top view of the vehicle of FIG. 4 including the drawer in the closed position, according to an exemplary embodiment.

FIG. 16 is a top view of the vehicle of FIG. 4 including the drawer in the open position, according to an exemplary embodiment.

FIG. 17 is a right perspective view of a frame of the vehicle of FIG. 4, according to an exemplary embodiment.

FIG. 18 is a rear perspective view of the frame of the vehicle of FIG. 4, according to an exemplary embodiment.

FIG. 19 is a right side view of the frame of the vehicle of FIG. 4, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle configured as a golf cart utilizes an electric drivetrain. Specifically, the electric drivetrain includes a battery pack including lithium-ion batteries. Other golf carts utilize lead acid batteries, which are less space efficient than lithium-ion batteries. Accordingly, the battery pack of the golf cart is capable of providing similar performance to the other golf carts while requiring less space.

The golf cart of the exemplary embodiment utilizes this vacant space for storage. The golf cart includes front row seating and a bed behind the front row seating. The battery pack of the golf cart is positioned directly beneath the seat, leaving an unoccupied area rearward of the battery pack, forward of a rear tractive assembly, and beneath the bed. Positioned within this space is a storage compartment or drawer. This drawer extends laterally across a body of the vehicle, and a portion of the drawer defines a side of the body. The drawer is repositionable between a retracted position in which the drawer is contained within the body and beneath the bed, and an extended position in which the drawer can be accessed by a user standing next to the golf cart.

### Overall Vehicle

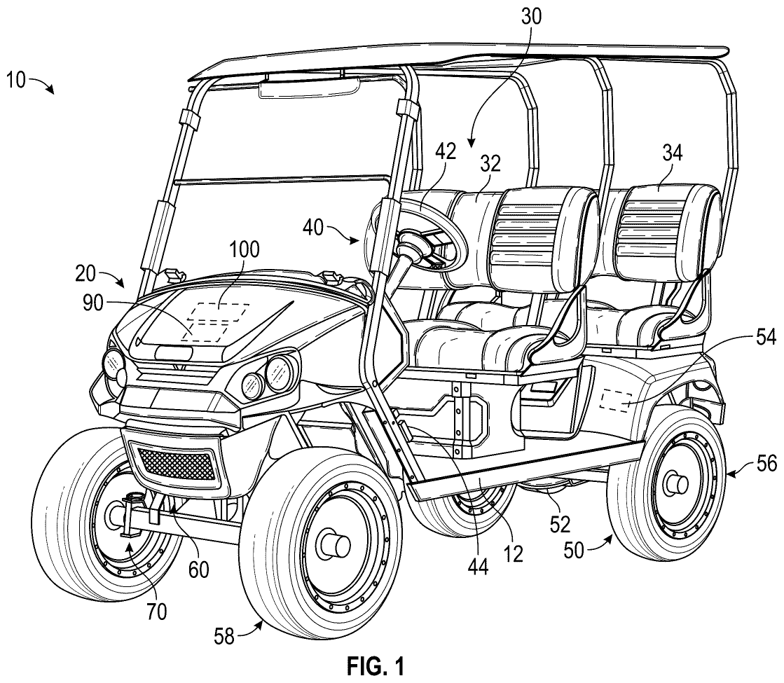

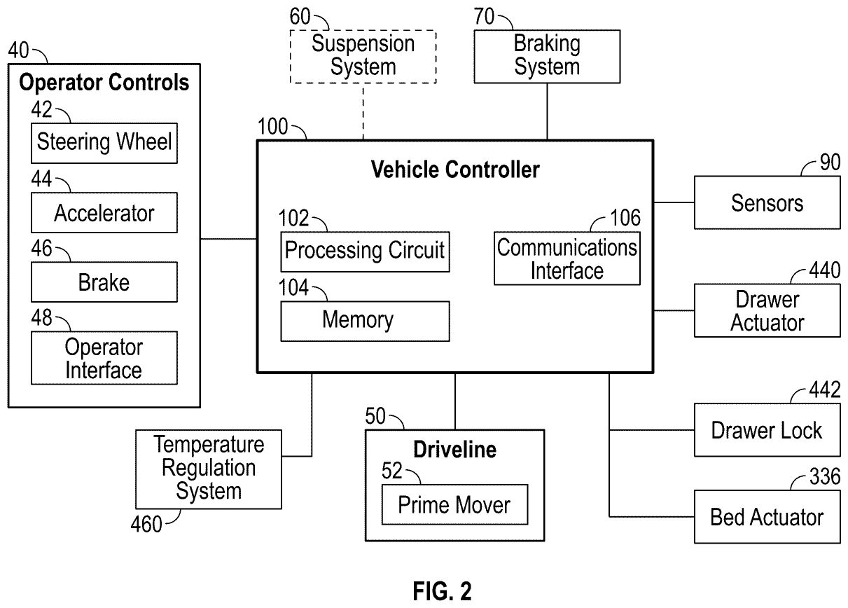

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle controller 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf vehicle (e.g., a golf cart), an all-terrain vehicle (“ATV”), a utility task vehicle (“UTV”), a low speed vehicle (“LSV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.) or rear axle assembly, shown as rear tractive assembly 56, and a second tractive assembly (e.g., axles, wheels, tracks, differentials, etc.) or front axle assembly, shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

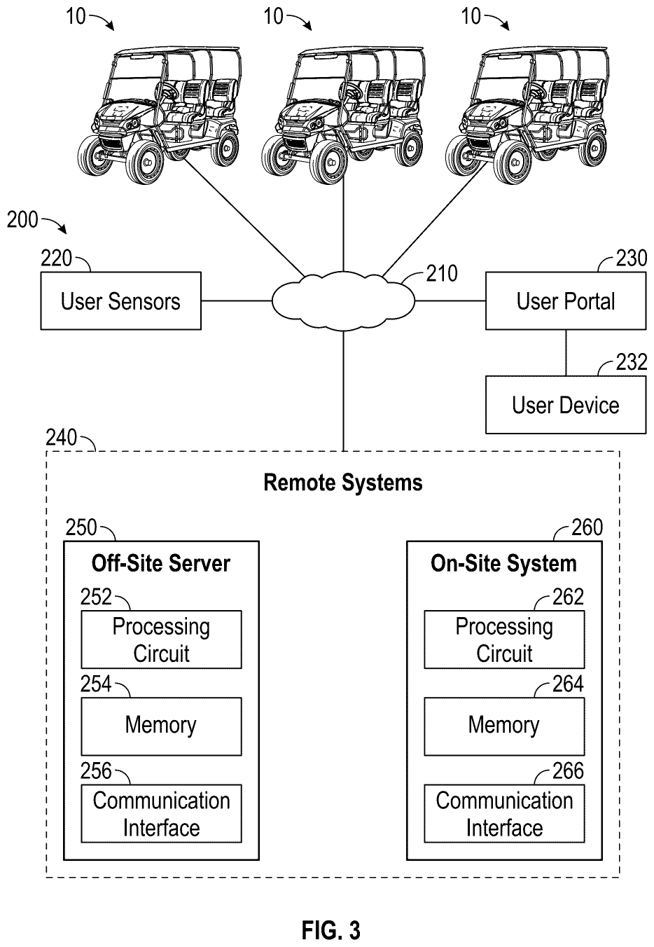

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 3, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Vehicle Structure

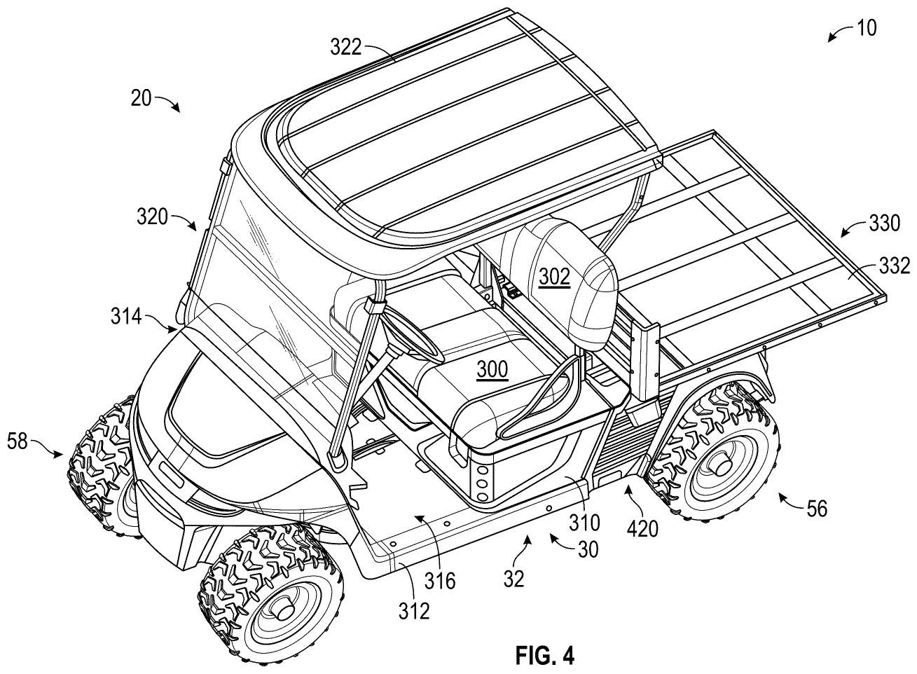

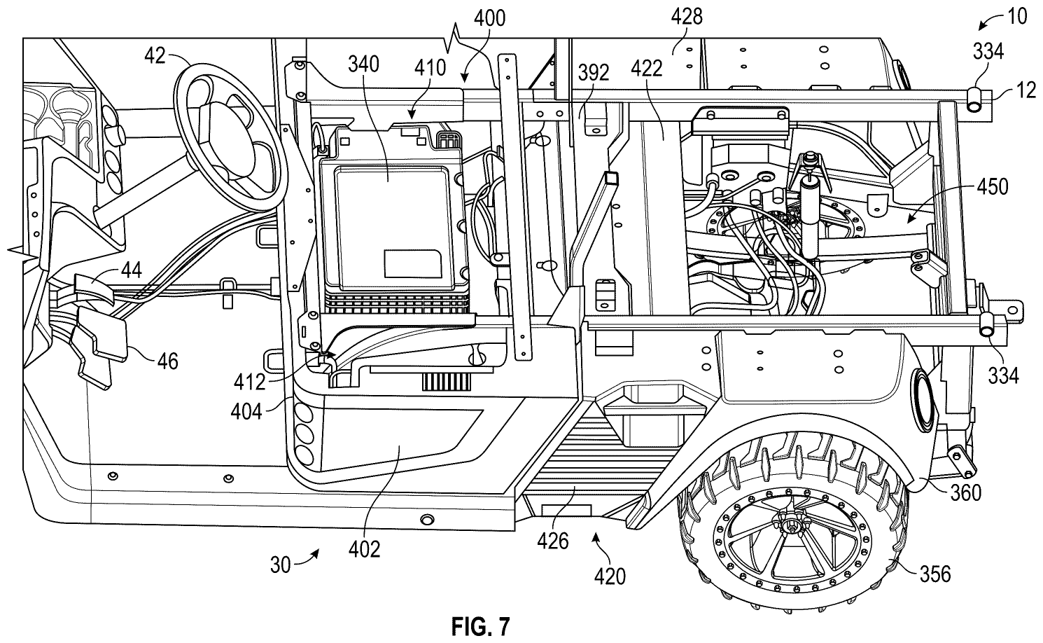

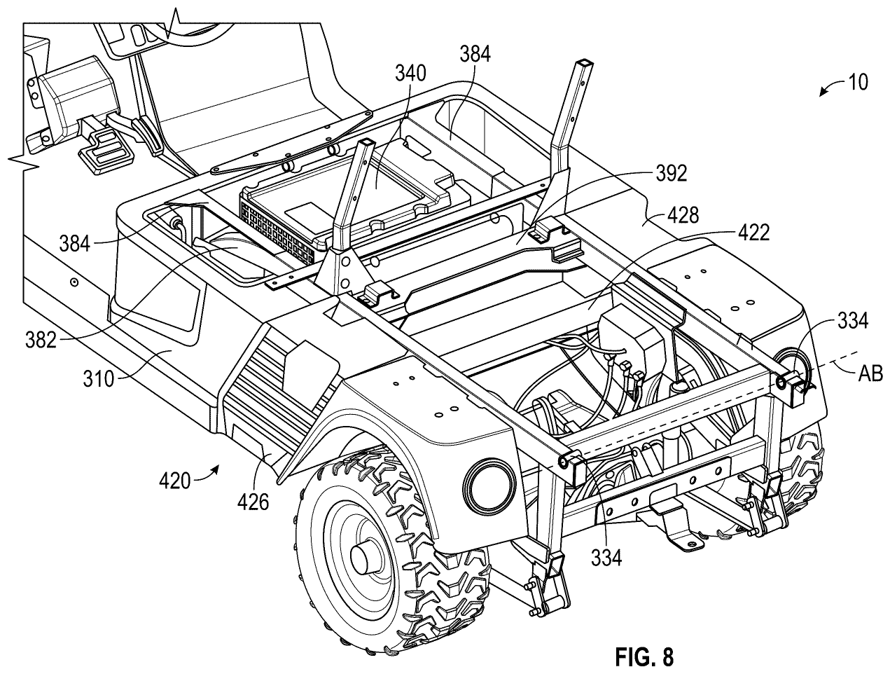

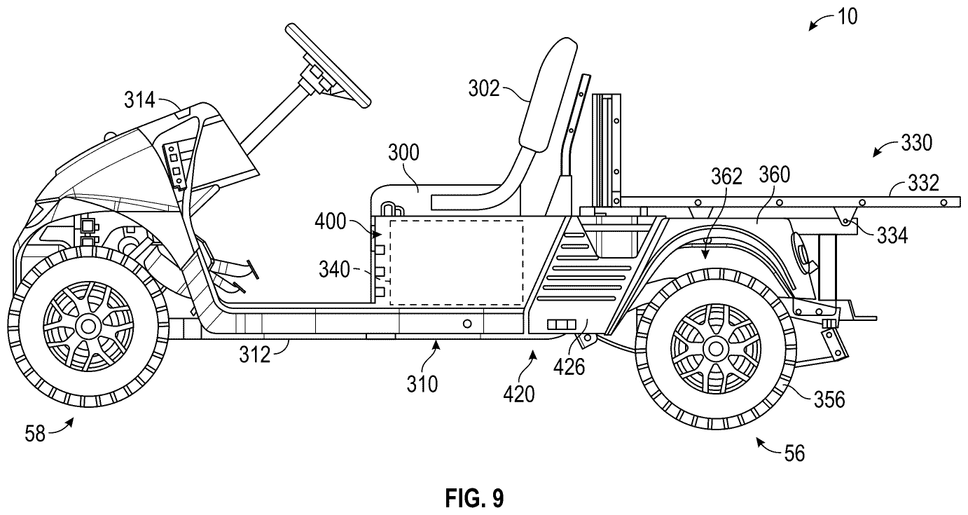

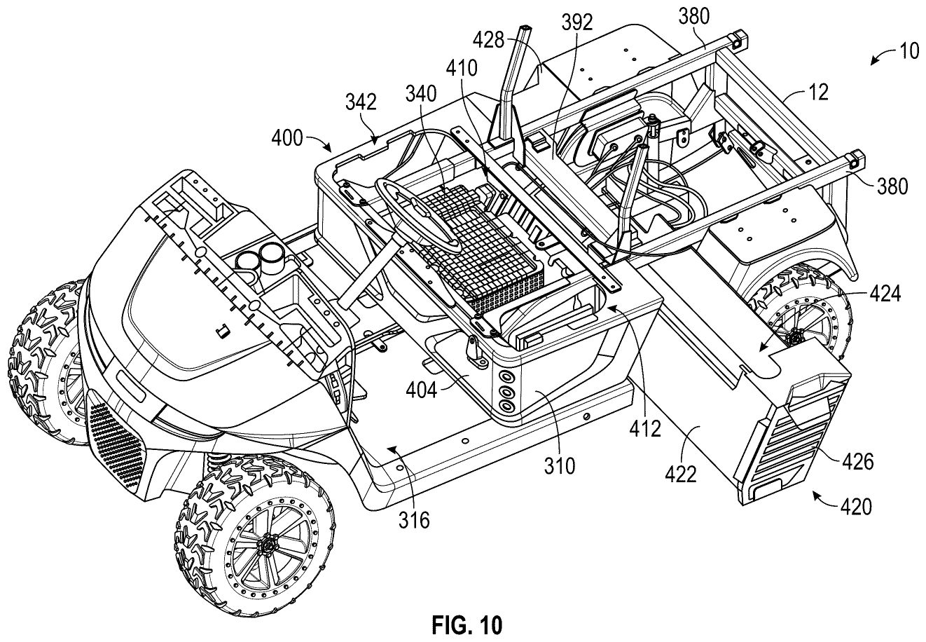

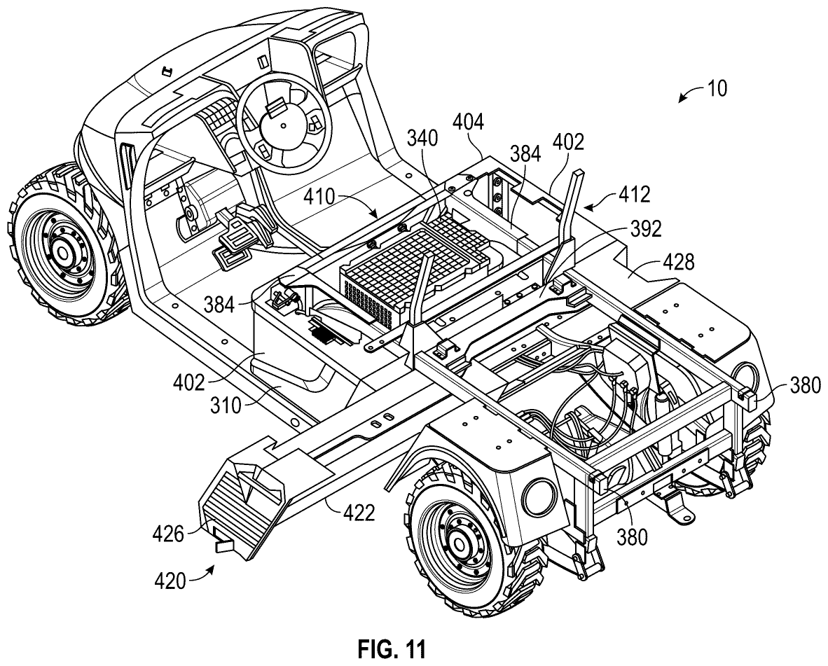

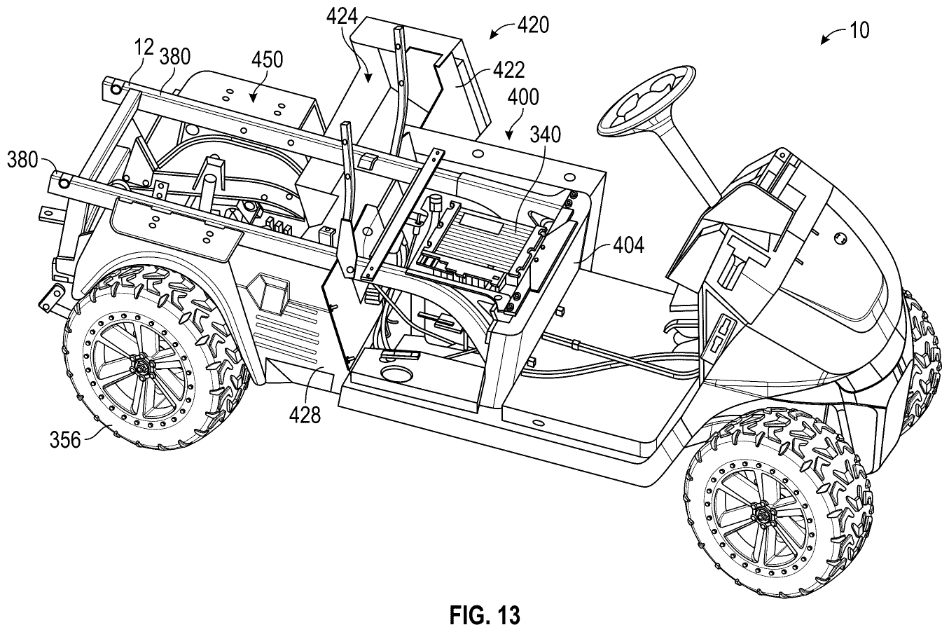

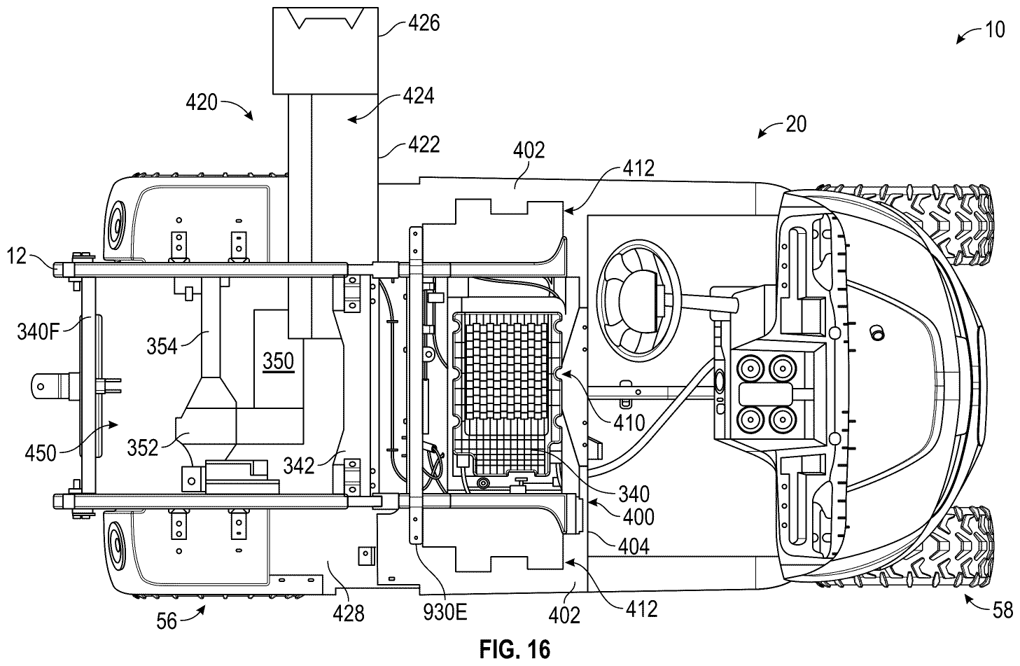

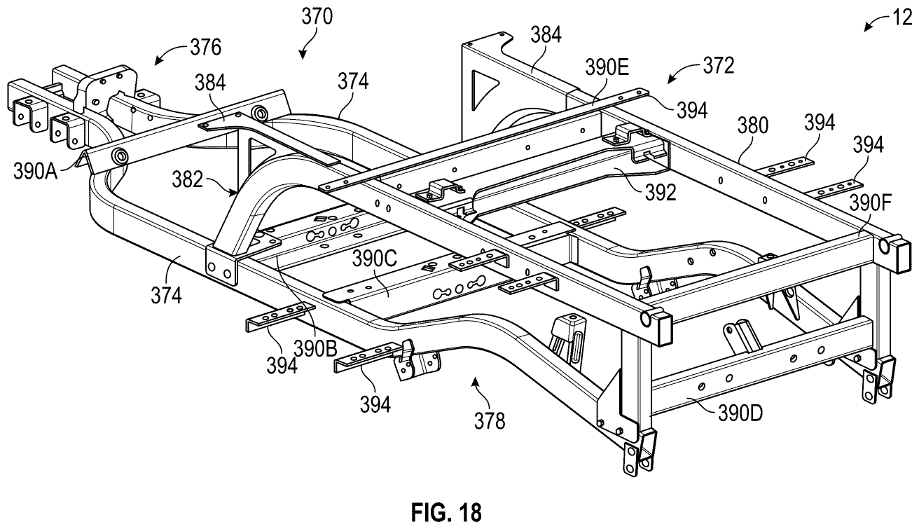

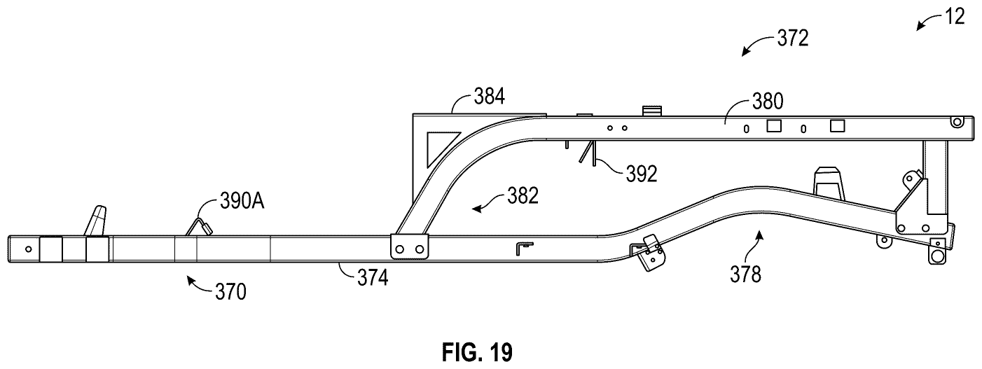

Referring to FIGS. 4-19, the vehicle 10 is shown according to an exemplary embodiment. The vehicle 10 of FIGS. 4-19 may be substantially similar to the vehicle 10 of FIG. 1 except as otherwise specified herein. In some embodiments, the vehicle 10 is configured as a golf vehicle.

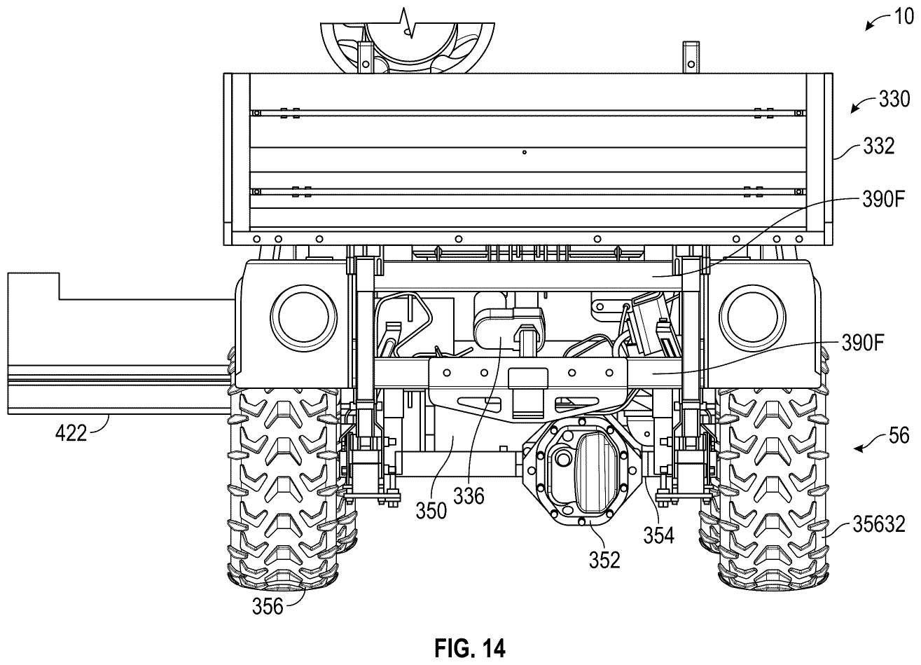

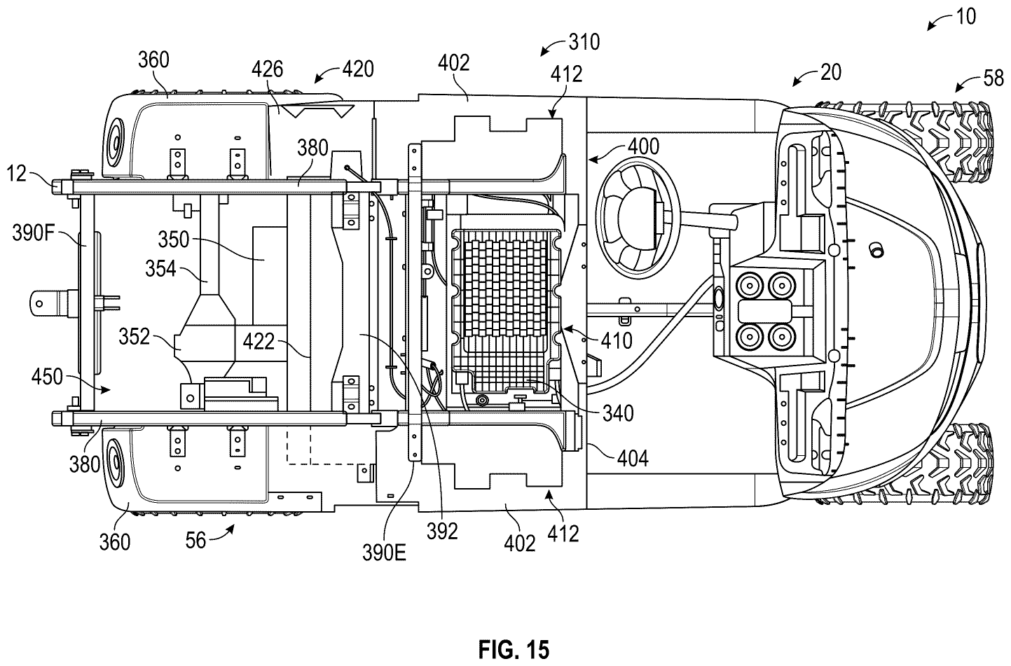

As shown in FIGS. 14 and 15, the vehicle 10 includes front row seating 32, and the rear row seating 34 is omitted. The front row seating 32 extends laterally across the body 20, from a right side of the body 20 (e.g., a first lateral side) to a left side of the body 20 (e.g., a second lateral side). Accordingly, the front row seating 32 may provide at least two seats (e.g., for an operator or driver and one or more passengers. The front row seating 32 includes a first seat portion, shown as seat bottom 300, and a second set portion, shown as seat back 302. The seat bottom 300 extends substantially horizontally and supports the bottom of the occupant. The seat back 302 extends substantially vertically and supports the back of the occupant.

The body 20 includes an under-seat portion, shown as seat box 310, that extends directly beneath and supports the seat bottom 300. The seat box 310 has a pair of lateral sides that extend along the left and right sides of the body 20, respectively, and a front side that extends between the lateral sides. The body 20 further includes a horizontal portion, shown as floor 312, that extends substantially horizontally, forward from the seat box 310 and toward a front end of the vehicle 10. The floor 312 may support the feet of an occupant as the occupant steps into the vehicle 10 (e.g., to enter or exit the front row seating 32). The body 20 further includes a front assembly or dashboard, shown as dash assembly 314. The dash assembly 314 is positioned at the front end of the floor 312 and extends upward from the floor 312. The dash assembly 314 may support and/or include one or more of the operator controls 40 (e.g., the steering wheel 42, the accelerator 44, the brake 46, etc.).

The body 20 defines a volume, shown as foot volume 316, that is sized and positioned to receive the lower body (e.g., feet and legs) of any occupants seated in the front row seating 32. The foot volume 316 is defined between the front side of the seat box 310, the top surface of the floor 312, and the rear side of the dash assembly 314. Accordingly, the foot volume 316 extends forward of and below the seat bottom 300. The foot volume 316 may extend laterally across and through the entire vehicle 10 to facilitate unobstructed lateral access to and egress from the vehicle 10.

The vehicle 10 further includes a transparent barrier (e.g., a window, a windscreen, a windshield, etc.), shown as windshield 320. The windshield 320 is coupled to the dash assembly 314 and extends upward from the dash assembly 314, substantially perpendicular to the direction of travel of the vehicle 10 (e.g., substantially laterally and vertically). The windshield 320 may protect the occupants from wind and debris while the vehicle 10 is driving. In some embodiments, the windshield 320 is removable. The windshield 320 may be omitted from various figures for clarity of illustration.

The vehicle 10 further includes a topper, shown as roof 322. The roof 322 is coupled to the body 20 (e.g., through the windshield 320 and/or the seat back 302). The roof 322 extends substantially horizontally above the front row seating 32, protecting the occupants from falling debris (e.g., rain, dust, sticks, etc.) and sunlight. In some embodiments, the roof 322 is removable. The roof 322 may be omitted from various figures for clarity of illustration.

In place of the rear row seating 34, the vehicle 10 includes an implement (e.g., a dump box, a dump bed, a cargo bed, etc.), shown as bed assembly 330. The bed assembly 330 is coupled to the frame 12 and positioned rearward of the front row seating 32. The bed assembly 330 is configured to store cargo (e.g., sporting equipment such as golf clubs or firearms, material such as stone, dirt, or mulch, etc.) for transportation by the vehicle 10.

As shown, the bed assembly 330 includes a container (e.g., a vessel, a bed, a bucket, a dumper, a cargo bed, etc.), shown as bed 332, that is pivotally coupled to a pair of bosses or bushings 334 of the frame 12. The bushings 334 align with one another to permit the bed 332 to pivot relative to the frame 12 about an axis AB. The axis AB is positioned at a rear end of the vehicle 10 and extends laterally. Accordingly, the bed 332 is repositionable between a first position, storage position, or transport position, shown in FIG. 4, and a second position, dumping position, or unloading position. In the transport position, the bed 332 is configured to support cargo. In the unloading position, the bed 332 is tilted upward relative to the transport position to facilitate dumping the cargo out of the bed 332.

As shown in FIGS. 2 and 14, the bed assembly 330 further includes an actuator (e.g., an electric linear actuator), shown as bed actuator 336, coupled to the frame 12 and the bed 332. In some embodiments, the bed actuator 336 is a linear actuator (e.g., an electric linear actuator, a hydraulic cylinder, etc.). The bed actuator 336 is configured to extend or retract to reposition the bed 332 between the transport position and the unloading position. By way of example, the bed actuator 336 may be controlled through the operator interface 48 and/or the user device 232. By including a powered actuator, the bed 332 may be moved to a desired position without requiring manual effort or with only minimal manual effort. In other embodiments, the bed 332 is manually repositioned. In yet other embodiments, the bed 332 is fixed in the transport position (i.e., is not movable).

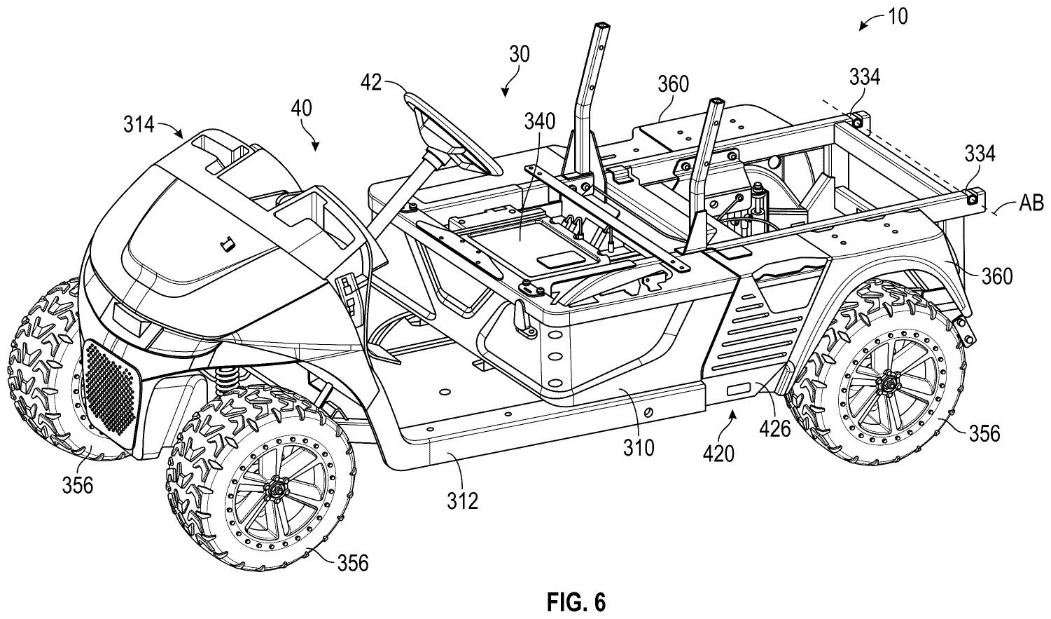

In some embodiments, the driveline 50 of the vehicle 10 is partially or completely electric. As shown in FIG. 6, the energy storage 54 includes an energy storage device, shown as battery pack 340, that provides some or all of the energy used to propel the vehicle 10. The battery pack 340 may store energy (e.g., as chemical energy) and provide the stored energy as electrical energy (e.g., direct current (DC) electrical energy) to the prime mover 52. Specifically, the electrical energy from the battery pack 340 is provided to the rear tractive assembly 56 (e.g., directly or through one or more power electronics) to power the rear tractive assembly 56 and propel the vehicle 10.

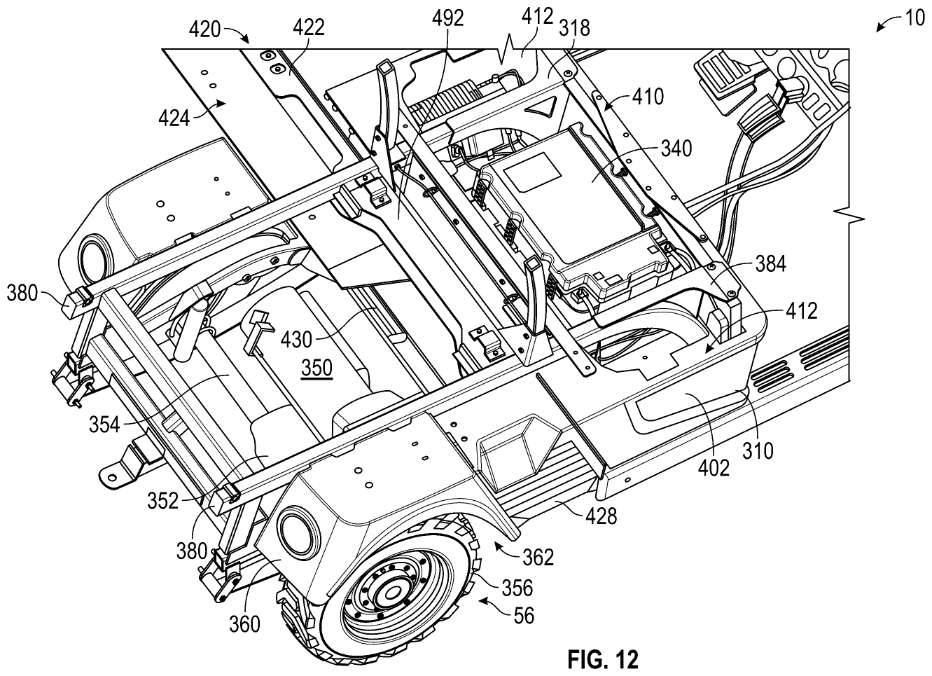

Referring to FIGS. 12 and 14-16, the rear tractive assembly 56 is shown according to an exemplary embodiment. The rear tractive assembly 56 may form a self-contained electronic axle assembly including a prime mover 52. As shown, the rear tractive assembly 56 includes an actuator, shown as electric motor 350, a gearbox, shown as power transmission 352, a pair of shafts, shown as axles 354, and a pair of tractive elements, shown as wheels 356. Specifically, the electric motor 350 is coupled to the power transmission 352, the power transmission 352 is coupled to the axles 354, and each axle 354 is coupled to one of the wheels 356.

In operation, the rear tractive assembly 56 receives electrical energy from the battery pack 340 and drives the wheels 356 to propel the vehicle 10. Specifically, the electric motor 350 may receive electrical energy and provide a rotational mechanical energy output to the power transmission 352. The power transmission 352 transfers the rotational mechanical energy to the axles 354. By way of example, the power transmission 352 may include a gearbox and/or differential that distributes the rotational mechanical energy between the axles 354. Each axle 354 transfers the rotational mechanical energy to one of the wheels 356. The wheels 356 then rotate while engaging the ground to propel the vehicle 10.

Referring to FIGS. 6-13, the body 20 includes a pair of rear body sections, shown as fenders 360, coupled to the frame 12. The fenders 360 are positioned along opposite lateral sides of the vehicle 10, rearward of the front row seating 32 and the seat box 310 and beneath the bed 332. Each of the fenders 360 defines a recess or volume, shown as wheel well 362. Each wheel well 362 receives one of the wheels 356 of the rear tractive assembly 56. Accordingly, each of the fenders 360 extend above one of the wheels 356 of the rear tractive assembly 56. The fenders 360 may facilitate capturing any debris (e.g., mud, rocks, etc.) that is released from the wheels 356 along an upward trajectory as the wheels 356 rotate.

As shown in FIG. 6, the front tractive assembly 58 also includes a pair of the wheels 356. However, the wheels 356 of the front tractive assembly 58 may not be directly powered by the prime mover 52 (e.g., may be free spinning). The wheels 356 of the front tractive assembly 58 may be rotatable about respective vertical axes to facilitate steering the vehicle 10.

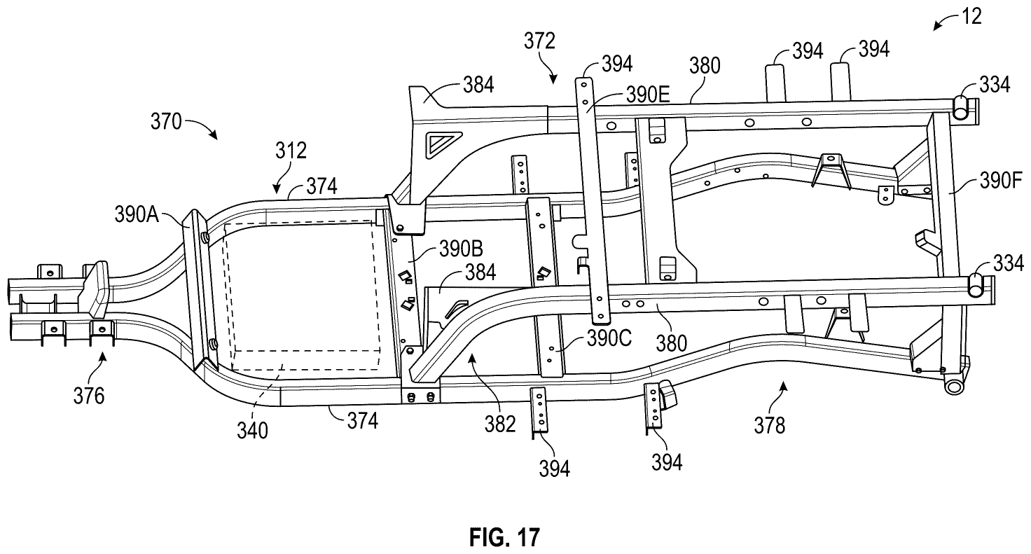

Referring to FIGS. 17-19, the frame 12 of the vehicle 10 is shown according to an exemplary embodiment. The frame 12 includes a series of frame members that are fixedly coupled to one another to form the frame 12. By way of example, the frame members may be fastened to one another (e.g., using one or more fasteners (e.g., bolts, rivets, etc.). By way of another example, the frame members may be welded to one another to form a weldment.

The frame 12 includes a bottom portion or lower portion 370 and a top portion or upper portion 372. The lower portion 370 extends generally horizontally and generally within a horizontal plane common to the floor 312. The lower portion 370 may support the floor 312, the front tractive assembly 58, and the rear tractive assembly 56. The upper portion 372 extends upward from the lower portion 370 and extends generally within a horizontal plane above the floor 312. The upper portion 372 may support the front row seating 32, the seat box 310, and the bed assembly 330.

The lower portion 370 includes a pair of longitudinal frame members, shown as lower frame rails 374. The lower frame rails 374 are laterally offset from one another and are symmetrical about a longitudinal and vertical center plane of the vehicle 10. The lower frame rails 374 extend generally longitudinally along the length of the vehicle 10. A front portion or narrowed portion 376 of each lower frame rail 374 near a front end of the vehicle 10 extends laterally inward, decreasing a distance between the lower frame rails 374. The narrowed portions 376 may permit the lower frame rails 374 to pass between the wheels 356 of the front tractive assembly 58 and provide clearance for the wheels 356 to facilitate steering. Each lower frame rail 374 includes a rear portion or arched portion 378 that arches upward near the rear end of the vehicle 10, forming a downward-facing recess. The arched portions 378 receive the rear tractive assembly 56.

The upper portion 372 includes a pair of longitudinal frame members, shown as upper frame rails 380. The upper frame rails 380 are laterally offset from one another and are symmetrical about the longitudinal and vertical center plane of the vehicle 10. The upper frame rails 380 extend generally longitudinally along the length of the vehicle 10. A front portion or upright portion 382 of each upper frame rail 380 extends upward and rearward from a corresponding lower frame rail 374, coupling the upper frame rail 380 to the lower frame rail 374. A support, shown as bracket 384, is fixedly coupled to an interior surface of each upright portion 382 and extends above the upper frame rail 380 to form a substantially horizontal mounting surface. The seat box 310 is coupled to this mounting surface, such that the bracket 384 couples the seat box 310 to the frame 12.

A series of lateral members, shown as cross members 390A, 390B, 390C, 390D, 390E, and 390F and referred to generally as cross members 390, extend laterally between the lower frame rails 374 or laterally between the upper frame rails 380. The cross members 390 maintain a fixed distance between the lower frame rails 374 and between the upper frame rails 380. An additional cross member, shown as drawer support 392, extends laterally between the upper frame rails 380 and is fixedly coupled to the upper frame rails 380. A series of supports, shown as mounting brackets 394, extend laterally outward from the lower frame rails 374 and the upper frame rails 380 and couple the body 20 to the frame 12. Some of the mounting brackets 394 are formed individually, and other mounting brackets 394 are integrally formed as a single, continuous piece with the one of the cross members 390.

### Storage Compartments

In some embodiments, the battery pack 340 includes batteries utilizing a lithium-ion battery chemistry (e.g., includes at least one lithium-ion battery). Other golf carts utilize alternative battery technologies, such as lead acid batteries, that are less space efficient than lithium-ion batteries. Accordingly, the battery pack 340 of the vehicle 10 is capable of providing similar performance to the other golf carts while requiring less space. By utilizing a lithium-ion battery pack, the vehicle 10 is provided with vacant space within the body 20.

Referring to FIGS. 6-16, the position of the battery pack 340 within the body 20 is shown. The battery pack 340 is positioned within a storage volume, shown seat storage volume 400, within the seat box 310. The seat box 310 includes a pair of side walls 402 and a front wall 404. The side walls 402 are positioned on the left and right sides of the vehicle 10, respectively. The side walls 402 extend substantially vertically and longitudinally and are laterally offset from one another. The front wall 404 extends laterally between the side walls 402. The side walls 402 and the front wall 404 extend upward from the floor 312 to the seat bottom 300. Accordingly, the seat storage volume 400 is defined between the side walls 402, between the floor 312 and the seat bottom 300, and rearward from the front wall 404.

The seat storage volume 400 is further divided into a series of storage compartments or storage volumes, shown as battery compartment 410 and side compartments 412. Specifically, the seat storage volume 400 is divided or partitioned by (a) a first frame rail subassembly including a first lower frame rail 374, a first upper frame rail 380, and a first bracket 384 and (b) a second frame rail subassembly including a second lower frame rail 374, a second upper frame rail 380, and a second bracket 384. The frame rail subassemblies extend longitudinally, substantially parallel to one another.

The battery compartment 410 is defined between the first frame rail subassembly and the second frame rail subassembly. Accordingly, the battery compartment 410 is approximately centered within the seat storage volume 400. The battery compartment 410 contains the battery pack 340, such that the battery pack 340 is positioned between the first frame rail subassembly and the second frame rail subassembly.

In some embodiments, the battery pack 340 is positioned elsewhere within the vehicle 10, or the vehicle 10 includes one or more additional battery packs 340 positioned throughout the vehicle 10. As shown in FIGS. 6 and 17, a battery pack 340 may be positioned within the floor 312. The battery pack 340 may be positioned between a top surface of the floor 312 (e.g., a surface that defines the foot volume 316) and a bottom surface of the floor 312. The top and bottom surfaces of the floor 312 may be defined by flat sheets of material (e.g., sheet metal) extending above and below the frame 12 to define a battery compartment that receives the battery pack 340. The battery compartment may extend laterally between the lower frame rails 374, such that the battery pack 340 is contained between the lower frame rails 374. By utilizing space within the frame 12 to store the battery pack 340, the vehicle 10 may be provided with additional storage capacity while freeing up other space within the vehicle 10 for storage.

Each side compartment 412 is positioned laterally outward from one of the frame rail subassemblies. Specifically, a first side compartment 412 is defined between the first frame subassembly and one of the side walls 402. A second side compartment 412 is defined between the second frame subassembly and the other of the side walls 402. Accordingly, the frame rail subassemblies are received between the side compartments 412, and the battery compartment 410 is received between the frame rail subassemblies.

The battery compartment 410 and the side compartments 412 may be used for storage. By way of example, the battery compartment 410 may be used to store the battery pack 340. Each side compartment 412 may be used to store equipment (e.g., sporting equipment), food and drink (e.g., within a cooler), components of the vehicle 10 (e.g., batteries, fluids, etc.), or other items. Items placed within the seat storage volume 400 may be enclosed and protected by the seat box 310 and the seat bottom 300.

In some embodiments, the battery compartment 410 and/or the side compartments 412 are selectively accessible through an opening defined along the top of the seat box 310. In some such embodiments, the seat bottom 300 is repositionable to permit access to this opening. The seat bottom 300 may be repositionable between (a) a use position in which the seat bottom 300 rests atop and is supported by the seat box 310 and/or the brackets 384 and (b) an access position in which the opening to the seat storage volume 400 is uncovered. By way of example, the seat bottom 300 may be pivotally coupled to the seat box 310, such that the seat bottom 300 may be lifted upward to access the seat storage volume 400. By way of another example, the seat bottom 300 may be removably coupled to the frame 12, such that the seat bottom 300 is removed to access the seat storage volume 400.

Referring to FIGS. 4-16, the vehicle 10 further includes a deployable storage assembly, shown as drawer assembly 420. The drawer assembly 420 is generally positioned between (a) the seat box 310 and (b) the fenders 360 and the rear tractive assembly 56. In other vehicles 10 (e.g., other golf vehicles) that do not utilize lithium-ion batteries, this space would normally be occupied by less space-efficient batteries. However, the small size of the battery pack 340 permits this space to be utilized for storage.

The drawer assembly 420 includes a sliding portion, shown as drawer 422, that extends laterally across the frame 12. The drawer 422 defines a storage compartment, shown as storage volume 424. The drawer 422 opens upward, such that the storage volume 424 is accessible through an opening at the top of the drawer 422. In some embodiments, the drawer 422 encloses the storage volume along the bottom, left, right, front, and rear sides (e.g., such that the drawer 422 forms a trough, bucket, or other upward-facing container). In some embodiments, the drawer 422 is longest in the lateral direction.

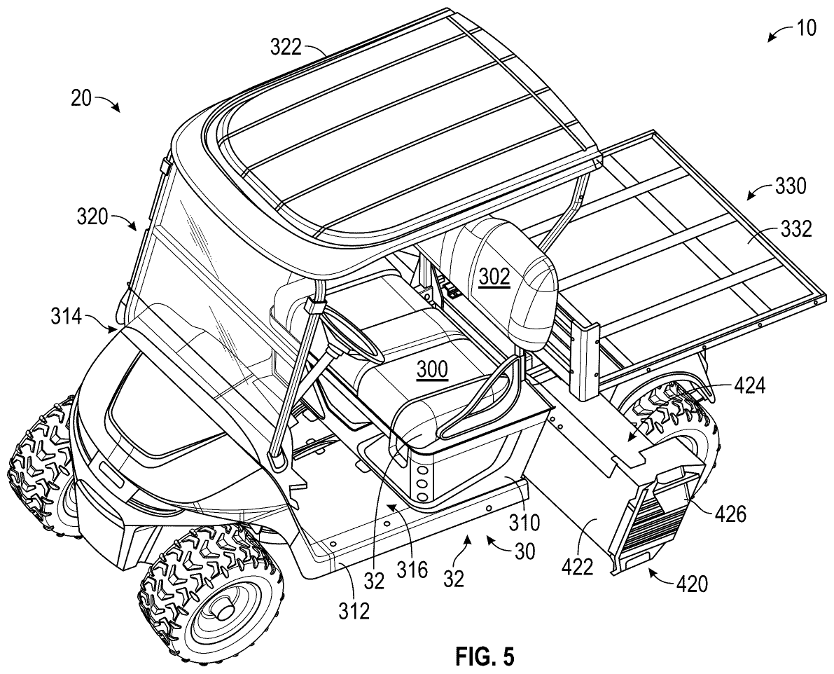

The drawer 422 is slidably coupled to the frame 12 and repositionable along a lateral axis between a retracted position (shown in FIGS. 4, 6-9, and 15) and an extended position (shown in FIGS. 5, 10-14, and 16). When in the retracted position, the drawer 422 extends between the lower portion 370 and the upper portion 372 of the frame 12. Accordingly, the drawer 422 is surrounded below by the lower frame rails 374 and above by the upper frame rails 380. Advantageously, the vertical spacing of the frame rails permits this placement of the drawer 422. Additionally, in the retracted position, the drawer 422 is enclosed within the body 20, protecting the contents of the drawer 422 from theft and ingress by outside contaminants.

When in the extended position, the drawer 422 is shifted laterally outward, extending the drawer 422 out of the body 20. The extended position of the drawer 422 exposes the storage volume 424, permitting a user to add items to the storage volume 424 or remove items from the storage volume 424. Specifically, a user may access the storage volume 424 from above. Accordingly, a user may place the drawer 422 in the extended position when adding or removing items and may place the drawer 422 in the retracted position when storing and/or transporting items.

The drawer assembly 420 includes a pair of end caps, panels, doors, or barriers, shown as drawer cap 426 and stationary cap 428. The drawer cap 426 is fixedly coupled to a first lateral end of the drawer 422, such that the drawer cap 426 moves with the drawer 422 relative to the frame 12. The stationary cap 428 is positioned adjacent a second end of the drawer 422 opposite the first end and is fixedly coupled to the frame 12. Accordingly, the drawer 422 and the drawer cap 426 are movable together relative to the stationary cap 428. In some embodiments, the drawer cap 426 and the stationary cap 428 are substantially symmetrical about a longitudinal centerline of the vehicle 10. The drawer cap 426 and the stationary cap 428 may visually obscure (e.g., hide) the drawer 422 when the drawer 422 is in the retracted position. As shown, the drawer cap 426 is positioned on the left side of the vehicle 10 and the stationary cap 428 is positioned on the right side of the vehicle 10, such that the drawer assembly 420 extends leftward when the drawer 422 is extended. In other embodiments, the drawer cap 426 is positioned on the right side of the vehicle 10 and the stationary cap 428 is positioned on the left side of the vehicle 10, such that the drawer assembly 420 extends rightward when the drawer 422 is extended.

The drawer 422 and the drawer cap 426 are slidably coupled to the frame 12 by one or more drawer slides, linear bearings, or sliding guides. A first drawer slide, shown in FIG. 12 as drawer slide 430, is positioned along an underside of the drawer 422 and slidably couples the drawer 422 to the frame 12. The drawer support 392 is coupled to the drawer 422. In some embodiments, the drawer support 392 also includes a drawer slide to facilitate sliding support of the drawer 422.

Referring to FIG. 2, the vehicle 10 further includes an actuator, shown as drawer actuator 440, operatively coupled to the vehicle controller 100. The drawer actuator 440 is configured to move the drawer 422 relative to the frame 12. By way of example, the drawer actuator 440 may include a linear actuator (e.g., an electric linear actuator, a hydraulic cylinder, etc.) that is coupled to the frame 12 and the drawer 422. The drawer actuator 440 may extend to move the drawer 422 toward the extended position or retract to move the drawer 422 toward the retracted position. Accordingly, the drawer actuator 440 may facilitate moving the drawer 422 without requiring manual user intervention. In other embodiments, the drawer actuator 440 is omitted, and the drawer 422 is moved manually.

Referring still to FIG. 2, the vehicle 10 further includes a latch or lock, shown as drawer lock 442, operatively coupled to the vehicle controller 100. The drawer lock 442 is configured to selectively limit movement of the drawer 422 relative to the frame 12. By way of example, the drawer lock 442 may include a latch that engages to hold the drawer 422 in the retracted position and/or a latch that engages to hold the drawer 422 in the extended position. To facilitate remote operation, the drawer lock 442 may include an actuator (e.g., a hydraulic cylinder, a solenoid, etc.) that actuates the latch. Beneficially, the drawer lock 442 may prevent the drawer 422 from unintentionally opening or closing.

In some embodiments, the vehicle controller 100 operates the drawer actuator 440 and/or the drawer lock 442 in response to a command from a user. The vehicle controller 100 may receive commands through the operator interface 48 and/or through a user device 232. By way of example, the user may provide a command or instruction to open the drawer 422, to close the drawer 422, to lock the drawer lock 442, and/or to unlock the drawer lock 442. In other embodiments, the drawer actuator 440 and/or the drawer lock 442 are controlled without the use of the vehicle controller 100 (e.g., electrically by supplying power through a switch or button, mechanically by operating a key or crank, etc.).

Referring to FIGS. 14 and 15, the vehicle 10 has a storage volume or storage space, shown as rear compartment 450. The rear compartment 450 is defined rearward of the drawer assembly 420. The rear compartment 450 extends laterally between the fenders 360 and below the bed 332. The rear compartment 450 receives the electric motor 350, the power transmission 352, the axles 354, and the bed actuator 336. In some embodiments, the rear compartment 450 provides sufficient space for the rear tractive assembly 56 to be inverted (e.g., such that the electric motor 350 faces rearward instead of forward).

Referring to FIGS. 4-19, the position of the drawer assembly 420 relative to the other components of the vehicle 10 is shown. The drawer 422 extends rearward of (e.g., more longitudinally rearward than) the front tractive assembly 58, the dash assembly 314, the foot volume 316, the front row seating 32, the seat box 310, the battery pack 340, and the seat storage volume 400. The drawer 422 extends forward of (e.g., more longitudinally forward than) the rear tractive assembly 56, the fenders 360, and the bed 332. The drawer 422 extends lower than (e.g., has a lower vertical coordinate than) the front row seating 32, the seat box 310, the battery pack 340, and the bed 332. The drawer 422 extends below (e.g., is overlapped by the plan view footprint of) the bed 332. The drawer 422 extends higher than (e.g., has a higher vertical coordinate than) the floor 312, the lower frame rails 374, and the wheels 356. The drawer 422 extends above (e.g., overlaps the plan view footprint of) the electric motor 350. The drawer 422 extends between the lower portion 370 and the upper portion 372 of the frame 12 (e.g., passes through an aperture defined between a lower frame rail 374 and an upper frame rail 380).

As shown, the front and rear sides of the drawer assembly 420 are inclined (e.g., not vertical or horizontal). The seat box 310 and the fenders 360 have similar, corresponding shapes. Accordingly, the seat box 310 extends above the drawer assembly 420. Similarly, the drawer assembly 420 extends above the fenders 360.

When the drawer 422 is extended, the drawer assembly 420 extends laterally outward beyond other components of the vehicle 10. Specifically, the drawer 422 and the drawer cap 426 extend laterally outward beyond the seat box 310, the bed 332, the left fender 360, the floor 310, and the wheels 356. This lateral extension may facilitate unobstructed access to the storage volume 424 by a user.

In some embodiments, the drawer cap 426 and/or the stationary cap 428 are instead configured as a door or hatch that is pivotally coupled to the frame 12 and/or the body 20. By way of example, the drawer cap 426 may pivot or rotate about a longitudinal (e.g., horizontal) axis positioned below the drawer cap 426, such that the drawer cap 426 opens downward. By way of another example, the drawer cap 426 may pivot or rotate about a longitudinal (e.g., horizontal) axis positioned above the drawer cap 426, such that the drawer cap 426 opens upward. By way of another example, the drawer cap 426 may pivot or rotate about an upwardly extending (e.g., vertical) axis positioned forward of the drawer cap 426, such that the drawer cap 426 opens forward. By way of another example, the drawer cap 426 may pivot or rotate about an upwardly extending (e.g., vertical) axis positioned rearward of the drawer cap 426, such that the drawer cap 426 opens rearward. The stationary cap 428 may have similar pivotal movements.

In some embodiments, the drawer cap 426 is pivotally coupled to the frame 12 and/or the body 20. In some such embodiments, the drawer cap 426 is decoupled from the drawer 422, and the drawer 422 is configured to slide independent of the drawer cap 426. By way of example, a user may open the drawer cap 426, then slide the drawer 422 outward past the drawer cap 426 to access the storage volume 424. In other embodiments, the drawer 422 is omitted, and the portion of the body 20 adjacent to the drawer assembly 420 defines the storage volume 424.

In some embodiments, the stationary cap 428 is pivotally coupled to the frame 12 and/or the body 20. By way of example, a user may open the stationary cap 428 to provide access from a side of the vehicle 10 opposite the drawer cap 426. In embodiments where the drawer 422 is present, the stationary cap 428 may provide an alternative point of access for the drawer 422 and/or a point for accessing a volume between the drawer 422 and the stationary cap 428 that would otherwise be inaccessible. In embodiments where the drawer 422 is omitted, the stationary cap 428 and the drawer cap 426 may each be pivotable to permit access to a continuous lateral storage volume 424 from both sides of the vehicle 10.

Although the drawer 422 is shown as moving laterally, in other embodiments the drawer 422 is movable in a different direction. By way of example, the drawer 422 may be opened and closed by moving along a longitudinal axis. In one such example, a drawer 422 is placed within the rear compartment 450, and the drawer 422 is opened by moving the drawer 422 rearward. Such a rearward-opening drawer may replace the drawer 422 of the drawer assembly 420 or be provided in addition to the drawer 422 of the drawer assembly 420. In another such example, the drawer 422 is opened by moving the drawer 422 forward.

In some embodiments, the drawer assembly 420 is partially or completely sealed (e.g., weatherproofed). By way of example, the drawer cap 426 may engage the body 20 when the drawer 422 is in the closed position. The drawer cap 426 may include a seal made from a compliant material (e.g., rubber, fabric, etc.) that confirms to seal against the body 20. By sealing the drawer assembly 420 when closed, the seal may prevent ingress of contaminants (e.g., dust, grass, rocks, insects, etc.) into the storage volume 424 and contaminating objects contained within the drawer assembly 420. The seal may also facilitate maintaining a temperature of the storage volume 424 (e.g., insulating the storage volume 424).

Referring to FIG. 2, the vehicle 10 includes a climate control system (e.g., a heating system, a cooling system, a refrigeration system, etc.), shown as temperature regulation system 460, operatively coupled to the vehicle controller 100. Operation of the temperature regulation system 460 may be controlled by the vehicle controller 100 (e.g., in response to a user selection of a desired temperature through the operator interface 48). The temperature regulation system 460 may control a temperature of (e.g., heat and/or cool) the storage volume 424 and the objects within the storage volume 424. In some embodiments, the drawer 422 is insulated to facilitate maintaining a desired temperature of the storage volume 424.

In some embodiments, the temperature regulation system 460 includes a heater (e.g., an electric resistance heater) that provides thermal energy to the drawer 422 to maintain or increase a temperature of the storage volume 424. By way of example, such a configuration may be useful to heat food products (e.g., sausages, burgers, etc.) or to warm clothing (e.g., boots, socks, gloves, etc.). In some embodiments, the temperature regulation system 460 includes a cooling system (e.g., a refrigeration circuit) that removes thermal energy from to the drawer 422 to maintain or decrease a temperature of the storage volume 424. By way of example, such a configuration may be useful to cool food products (e.g., beverages, ice, etc.) or to cool clothing (e.g., boots, socks, gloves, etc.).

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle controller 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf vehicle comprising:
a frame;
a body coupled to the frame and defining a battery compartment;
a tractive element coupled to the frame;
an electric motor configured to drive the tractive element to propel the golf vehicle;
a battery positioned within the battery compartment and configured to supply electrical energy to the electric motor; and
a drawer movably coupled to the frame and extending rearward of the battery compartment, the drawer defining a storage volume.

2. The golf vehicle of claim 1, wherein the drawer is slidably coupled to the frame and laterally repositionable between a retracted position and an extended position, wherein the drawer is configured to move laterally outward relative to the frame when the drawer moves from the retracted position to the extended position.

3. The golf vehicle of claim 2, further comprising an actuator coupled to the frame and configured to move the drawer between the retracted position and the extended position in response to a command from a user through a user interface.

4. The golf vehicle of claim 2, wherein the frame includes an upper frame portion and a lower frame portion, and wherein the drawer extends between the upper frame portion and the lower frame portion when the drawer is in the retracted position.

5. The golf vehicle of claim 1, wherein the electric motor is positioned rearward of the battery, and wherein the drawer extends between the battery and the electric motor.

6. The golf vehicle of claim 5, further comprising a seat coupled to the frame and configured to support an operator, wherein the battery extends directly below the seat.

7. The golf vehicle of claim 6, wherein the battery compartment includes an opening, and wherein the seat is movably coupled to the frame and repositionable to selectively extend across the opening.

8. The golf vehicle of claim 7, wherein the frame includes a first frame rail and a second frame rail, the second frame rail being laterally offset from the first frame rail, wherein the battery extends between the first frame rail and the second frame rail, and wherein the first frame rail at least partially supports the seat when the seat extends across the opening.

9. The golf vehicle of claim 1, further comprising a bed coupled to the frame and configured to support cargo, wherein the drawer extends below the bed.

10. The golf vehicle of claim 1, wherein the battery is a lithium-ion battery.

11. An off-road machine comprising:
a frame;
a front tractive assembly coupled to the frame and including a first tractive element;
a rear tractive assembly coupled to the frame and including a second tractive element;
a seat configured to support an operator, the seat extending forward of the rear tractive assembly; and
a body defining a storage volume extending forward of the second tractive element and rearward of the seat, wherein the body includes a panel that is repositionable to selectively permit access to the storage volume from outside of the body.

12. The off-road machine of claim 11, wherein the body includes a drawer at least partially formed by the panel, wherein the drawer is slidably coupled to the frame and repositionable between a retracted position and an extended position, wherein the drawer defines the storage volume, wherein the storage volume extends forward of the second tractive element when the drawer is in the retracted position, wherein the storage volume extends rearward of the seat when the drawer is in the retracted position.

13. The off-road machine of claim 12, wherein the storage volume of the drawer extends lower than the seat when the drawer is in the retracted position.

14. The off-road machine of claim 13, further comprising a seat box coupled to the frame, extending below the seat, and defining a storage compartment, wherein the storage volume of the drawer extends rearward of the seat box when the drawer is in the retracted position.

15. The off-road machine of claim 14, further comprising a fender coupled to the frame and defining a wheel well that receives the second tractive element, wherein the storage volume of the drawer extends forward of the fender when the drawer is in the retracted position.

16. The off-road machine claim 15, further comprising a bed coupled to the frame and configured to support cargo, wherein the drawer extends below the bed when the drawer is in the retracted position.

17. The off-road machine of claim 16, wherein the drawer extends laterally outward of the bed when the drawer is in the extended position, wherein the bed is pivotally coupled to the frame and configured to rotate relative to the frame about an axis of rotation that extends laterally, and wherein the drawer extends forward of the axis of rotation.

18. The off-road machine of claim 11, wherein the panel is pivotally coupled to the frame.

19. The off-road machine of claim 11, wherein the off-road machine is at least one of golf vehicle, an all-terrain vehicle, a utility task vehicle, a low speed vehicle, a mower, an aerator, a turf sprayer, or a bunker rake.

20. A recreational vehicle comprising:
a frame including an upper frame portion and a lower frame portion;
a seat box coupled to the frame and defining a battery compartment;
a seat extending across the battery compartment and at least partially supported by the upper frame portion;
a tractive assembly coupled to the frame and extending rearward of the seat, the tractive assembly including a tractive element and an electric motor configured to drive the tractive element to propel the golf vehicle;
a battery positioned within the battery compartment and configured to supply electrical energy to the electric motor;
a fender coupled to the frame and defining a wheel well that receives the tractive element;
a bed pivotally coupled to the frame and extending above the upper frame portion; and
a drawer slidably coupled to the frame and defining a storage volume, wherein the drawer extends between the upper frame portion and the lower frame portion, wherein the drawer extends between the seat box and the fender, wherein the drawer extends between the electric motor and the battery, and wherein the drawer extends below the bed.
